(19) United States
(12) Patent Application Publication
(10) Pub. No.: US 2016/0181625 A1
(43) Pub. Date: Jun. 23, 2016

(54) POROUS CHANNEL STRUCTURE FOR FUEL CELL

(71) Applicant: Hyundai Motor Company, Seoul (KR)

(72) Inventors: Yoo Chang Yang, Gunpo (KR); Sang Mun Jin, Yongin (KR)

(21) Appl. No.: 14/699,423

(22) Filed: Apr. 29, 2015

(30) Foreign Application Priority Data
Dec. 18, 2014 (KR) 10-2014-0183249

(51) Int. Cl. H01M 8/02

(52) U.S. Cl. CPC H01M 8/026

(57) ABSTRACT

A porous channel structure for a fuel cell includes a channel plate including a plurality of land parts contacting a gas diffusion layer (GDL) to form a waveform cross-section along a flow direction of gas and a plurality of channel parts contacting a flat plate to maintain water tightness, and having a channel hole through which reaction gas passes. The channel hole is punched to include a portion of at least one of a land part of the plurality of land parts and a channel part of the plurality of channel parts.

### CROSS-REFERENCE TO RELATED APPLICATION

This application claims priority to and the benefit of Korean Patent Application No. 10-2014-0183249, filed on Dec. 18, 2014 in the Korean Intellectual Property Office, the disclosure of which is incorporated herein in its entirety by reference.

### TECHNICAL FIELD

The present disclosure relates generally to a porous channel structure for a fuel cell, and more particularly, to a porous channel structure for a fuel cell capable of allowing horizontal and vertical reaction gas flow.

### BACKGROUND

As illustrated in FIGS. 1 and 2, a fuel cell 1 to which a metal bipolar plate is applied generally has a structure in which a membrane-electrode assembly (MEA) 3 is disposed between metal bipolar plates 6 and 7 having channels for reaction gas and cooling water formed therein, as well as a gas diffusion layer (GDL) 2 assisting a diffusion of the reaction gas. A chemical reaction is produced in the membrane-electrode assembly 3. The metal bipolar plates 6 and 7 are repeatedly provided with a channel part 4 which does not contact the GDL in the same direction as a flow of the reaction gas and a land part 5 contacting the GDL. Further, the metal bipolar plates are divided into an anode bipolar plate 6 and a cathode bipolar plate 7 which correspond to an anode and a cathode, respectively. The anode bipolar plate 6 and the cathode bipolar plate 7 are stacked and joined so that a channel part 4 and a land part 5 are symmetrical with each other, thereby forming a cooling channel 8 through which cooling water flows.

Therefore, channel parts 4 and 4′ of the anode bipolar plate 6 and the cathode bipolar plate 7, which are passages for each reaction gas, are present along the same line. The reaction gas which flows in the channel part 4′ of the anode bipolar plate 6′ and the reaction gas which flows in the channel part 4 of the cathode bipolar plate 7 flow in the same direction or reversely. Generally, to maximize performance of the fuel cell, the reaction gas which flows in each bipolar plate flows reversely.

Further, to maximize the performance of the fuel cell, an interval between the channel part 4 and the land part 5 is densely formed. In this case, this may make a surface pressure applied to the GDL 2 and the MEA 3 uniform and may make the GDL 2 have constant transmittance over the whole surface of the GDL 2. However, to prevent defects from occurring during molding (e.g., cracks, a spring back phenomenon of making a shape return to a previous shape, etc.), there can be a limitation in reducing the interval between the channel part 4 and the land part 5.

As described below, a reduction in performance of the fuel cell occurs due to manufacturing limitations. For instance, when a channel pitch defined by a length at which the channel part 4 and the land part 5 are once repeated is large, stress can be concentrated on the land surface where the metal bipolar plates 6 and 7 and the GDL 2 contact each other, thereby making the surface pressure non-uniform. Therefore, the porous structure of the GDL 2 would be destroyed, and as a result, permeability of the GDL 2 deteriorates, while the diffusivity of the reaction gas and a discharge property of the produced water also deteriorate. Further, the GDL 2 is permeated into the channel part 4 to hinder the flow of the reaction gas. The channel pitch is large, and thus, the stress is concentrated on the land surface. As a result, when the GDL 2 is destroyed, carbon fiber is permeated from the land part 5 up to the MEA 3, causing damage to the MEA 3. Further, the surface pressure between the GDL 2 and the MEA 3 of the channel part is insufficient to increase a contact resistance, thereby making movement of generated electrons difficult.

Meanwhile, to address a problem with the above-described conventional fuel cell, instead of the existing metal bipolar plate, as illustrated in FIG. 3, a technique of inserting a porous structure 10 having an open flow field shape, in which a plurality of channel holes 9 are formed, between plates which divide the GDL and the cooling water passage, has emerged. However, in the fuel cell including the existing porous structure 10, since the channel hole 9 is present only on an inclined surface of a cross-section of the channel, and thus the reaction gas 11 passing through the channel hole stops by the structure to horizontally form turbulence. Consequently, the flow development of the reaction gas 11 toward the MEA/GDL is insufficient.

### SUMMARY

The present disclosure has been made to solve the above-mentioned problems occurring in the related art while advantages achieved by the related art are maintained intact.

An aspect of the present disclosure provides a porous channel structure for a fuel cell capable of improving efficiency of a fuel cell by solving an insufficient flow development of reaction gas in an MEA/GDL, which is a disadvantage of the conventional fuel cell into which a porous structure is inserted.

According to embodiments of the present disclosure, a porous channel structure for a fuel cell includes: a channel plate including a plurality of land parts contacting a gas diffusion layer (GDL) to form a waveform cross-section along a flow direction of gas and a plurality of channel parts contacting a flat plate to maintain water tightness, and having a channel hole through which reaction gas passes. The channel hole is punched to include a portion of at least one of a land part of the plurality of land parts and a channel part of the plurality of channel parts.

The channel hole may include: a first type channel hole configured to be punched and including a portion contacting the GDL in the land part; and a second type channel hole configured to be punched and including a portion contacting the flat plate in the channel part.

The first type channel hole and the second type channel hole may be formed in plural at equidistance from one another along a wave direction of the channel plate.

The first type channel hole and the second type channel hole may be formed to be positioned along a diagonal line of the channel plate.

The reaction gas may move along a curved surface of any of the plurality of land parts, causing directivity and vertical flows in the flat plate, when the reaction gas passes through the first type channel hole.

The reaction gas may move along a curved surface of any of the plurality of channel parts, causing directivity and vertical flows in the GDL, when the reaction gas passes through the second type channel hole.

A shape of the channel hole may be one of a circle, an oval, and a quadrangle.

Furthermore, according to embodiments of the present disclosure, a porous channel structure for a fuel cell includes a channel plate including a plurality of land parts contacting a gas diffusion layer (GDL) to form a waveform cross-section along a flow direction of gas and a plurality of channel parts contacting a flat plate to maintain water tightness, and having a channel hole through which reaction gas passes. The channel hole is formed to simultaneously perforate a land part of the plurality of land parts and a channel part of the plurality of channel parts.

A width of the channel hole may be formed to be equal to or greater than a pitch length which is a sum of a width of the land part and a width of the channel part.

The reaction gas may pass through the channel hole to simultaneously form vertical turbulence and horizontal turbulence.

The channel hole may include a plurality of holes formed in plural at equidistance from one another along a valley formed by a channel.

### BRIEF DESCRIPTION OF THE DRAWINGS

The above and other objects, features and advantages of the present disclosure will be more apparent from the following detailed description taken in conjunction with the accompanying drawings:

FIG. 1 is a cross-sectional view of main parts of a conventional fuel cell;

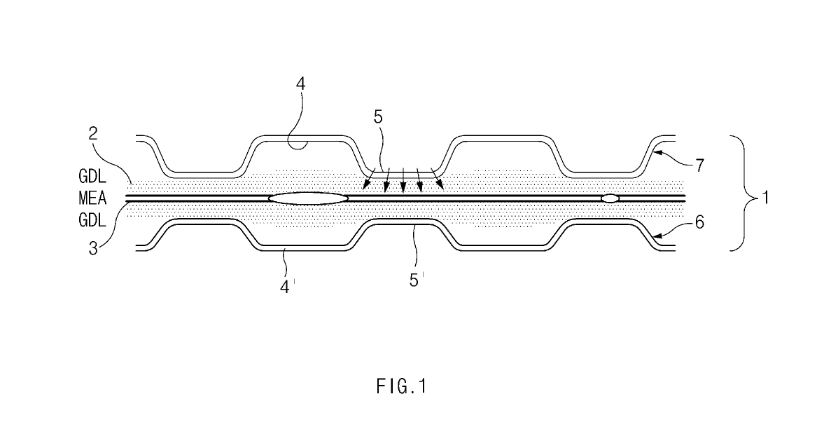

FIG. 2 is a perspective view and a cross-sectional view of main parts of a conventional fuel cell;

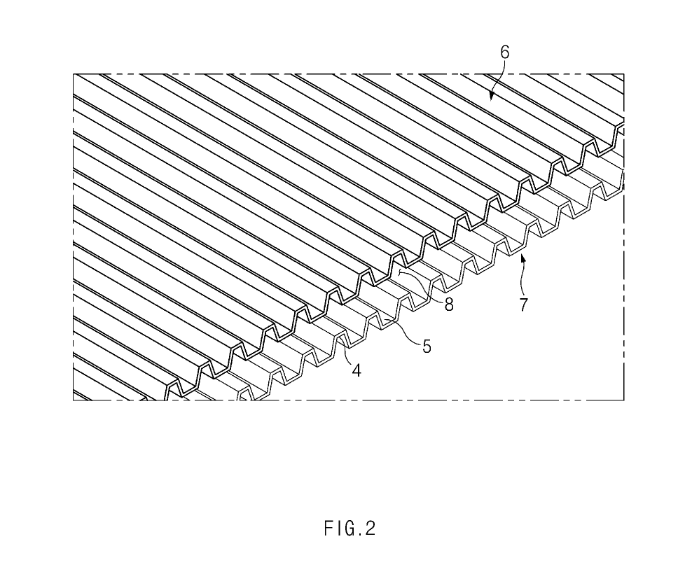

FIG. 3 is a plan view of a porous structure included in the conventional fuel cell and a cross-sectional view of main parts of the porous structure included in the conventional fuel cell;

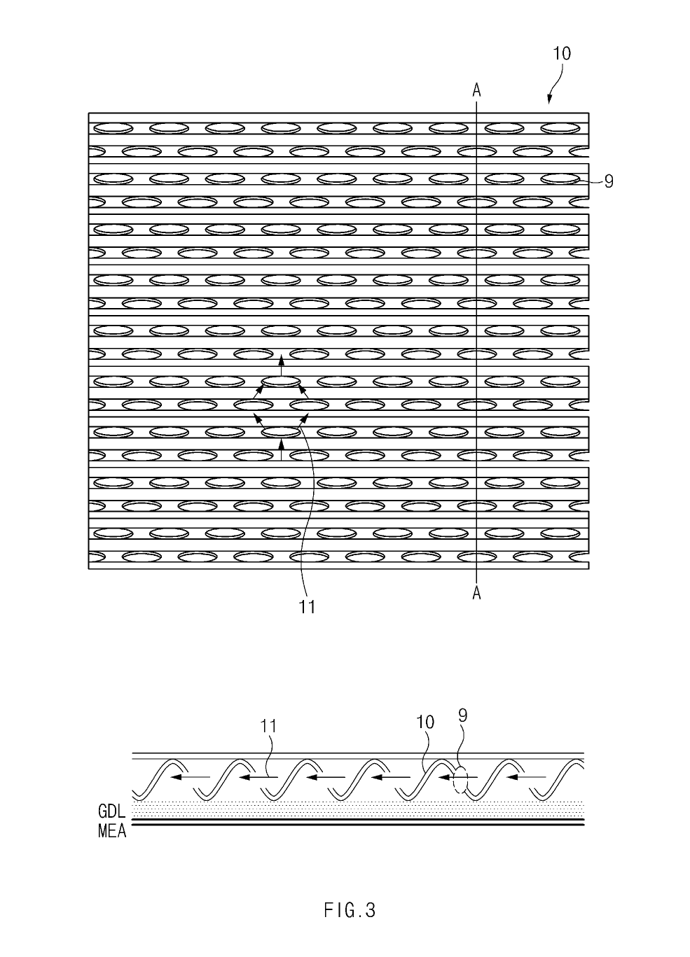

FIG. 4 is a perspective view of main parts of a porous channel structure for a fuel cell according to embodiments of the present disclosure;

FIG. 5 is a plan view of the porous channel structure for a fuel cell of FIG. 4;

FIG. 6 is a cross-sectional view taken along the line A-A′ of FIG. 5;

FIG. 7 is a cross-sectional view taken along the line B-B′ of FIG. 5; and

FIG. 8 is a graph illustrating performance of the conventional fuel cells to which the porous structure and the porous channel structure for a fuel cell according to embodiments of the present disclosure are applied.

### DETAILED DESCRIPTION

Embodiments of the present disclosure will be described below in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

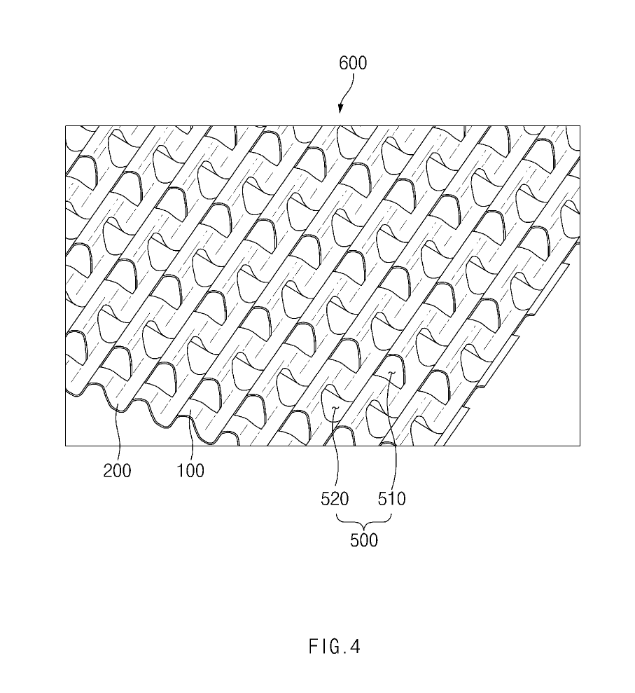

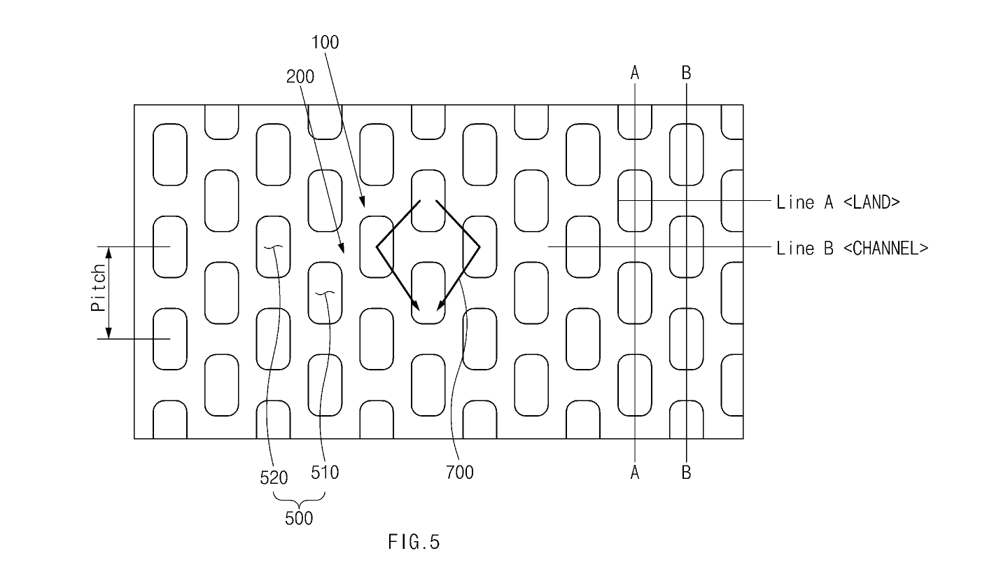

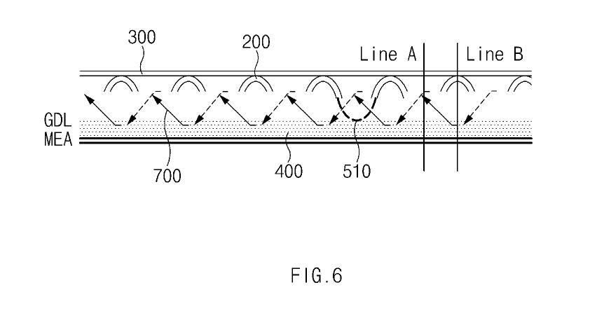

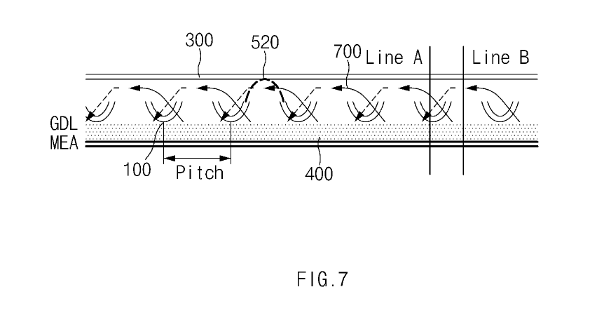

Referring now to the disclosed embodiments, as illustrated in FIGS. 4 to 8, a porous channel structure for a fuel cell according to embodiments of the present disclosure includes a channel plate 600 configured to be repeatedly provided with a plurality of land parts 100 contacting a gas diffusion layer (GDL) 400 to form a waveform cross-section and a plurality of channel parts 200 contacting a flat plate 300 to maintain water tightness and regularly provided with at least one finely formed channel hole 500 through which reaction gas 700 passes, in which a width of the channel hole 500 is formed at about ½ of a pitch which is a sum of a length of the land part 100 and a length of the channel part 200. The length of the channel hole 500 may be determined based on an interval between the channel holes 500 and a flow analysis result of the reaction gas 700.

The at least one finely formed channel hole 500 includes first type channel holes 510, some of which includes the land part 100 and second type channel holes 520, some of which includes the channel part 200. According to embodiments of the present disclosure, the first type channel hole 510 is punched, including a portion contacting the GDL 400 in the land part 100 and the second type channel hole 520 is punched, including a portion contacting the flat plate 300 in the channel part 200.

The first type channel hole 510 and the second type channel hole 520 are formed in plural at equidistance from one another along a wave direction of the channel plate 600. In this case, the first type channel hole 510 and the second type channel hole 520 form any diagonal line (e.g., along the channel plate 600) which connects a vertical side of the channel plate 600 to a horizontal side thereof and are repeatedly disposed so as to form the plurality of channel holes 500. More specifically, the plurality of first type channel holes 510 and the plurality of second type channel holes 520 are repeatedly formed on any extending line which forms an angle of 0° to 90° to a longitudinal central axis of the first type channel hole 510 or the second type channel hole 520 based on a center of the first type channel hole 510 or the second type channel hole 520 as a central point. Further, the channel holes 500 having the same shape are formed in plural at equidistance from one another along a valley which is formed by the land part 100 or the channel part 200.

The reaction gas 700 passing through the first type channel hole 510 moves along a curved surface of the land part 100 causing directivity and vertical flows in the flat plate 300. The reaction gas 700 passing through the second type channel hole 520 moves along a curved surface of the channel part 200 causing directivity and vertical flows in the GDL 400. That is, the turbulence is formed vertically and the reaction gas 700 passing through the first and second type channel holes 510 and 520 flows in the GDL 400, and therefore the flow amount of reaction gas in the GDL 400 can be improved.

Meanwhile, the reaction gas passing through the at least one finely formed channel hole 500 horizontally flows along the shape of the channel hole 500. That is, the turbulence is formed horizontally. In particular, when the channel hole 500 is formed in a rectangle, more accurately, a diamond shape, a friction between the channel hole 500 and the reaction gas 700 is increased and a size of the horizontal turbulence is increased accordingly. The shape of the channel hole 500 may be any one of a circle, an oval, and a quadrangle. The reaction gas 700 passing through the channel hole 500 moves along the curved surface of the channel part 200 or the land part 100 to form a vertical turbulence. Further, the horizontal turbulence is formed by the shape of the channel hole 500 and the diffusion to the channel part 200 and the land part 100.

In particular, due to the vertical turbulence, the flow amount of reaction gas in the GDL 400 is more improved than that in the case in which the porous structure according to the related art is mounted. Furthermore, due to the horizontal turbulence, the flow of reaction gas 700 between the first type channel hole 510 and the second type channel hole 520 is smoothly performed.

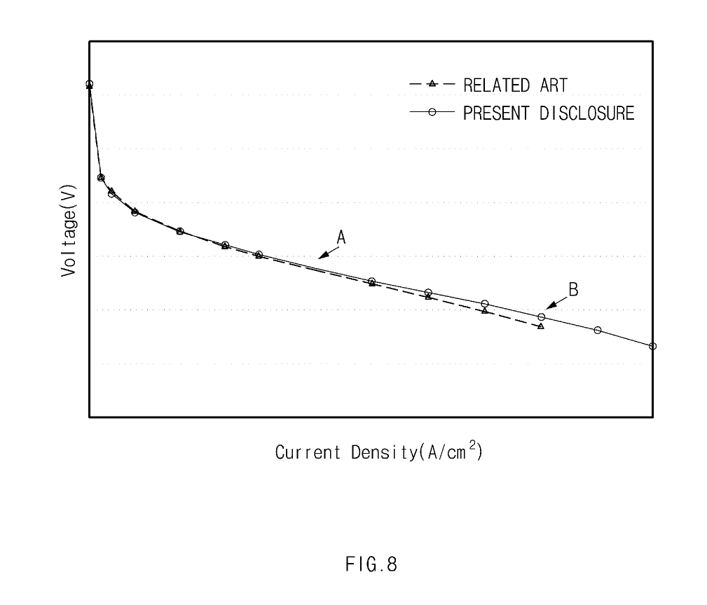

FIG. 8 is a graph illustrating performance of the conventional fuel cells to which the porous structure and the porous channel structure for a fuel cell according to embodiments of the present disclosure are applied.

In the graph of FIG. 8, a horizontal axis represents a current density and a vertical axis represents a voltage. In a region under point A, there is little difference between the case in which the porous structure according to the present disclosure is mounted and the case in which the existing porous structure is mounted. However, the difference therebetween in a region after point A gradually increases, and a voltage improvement effect of 4.4% appears at point B. Considering characteristics of the fuel cell, it is expected that the difference will increase toward a region of current density, i.e., beyond point B. Representing the same voltage in the greater current density region means that even though a smaller reaction area, the same output may be generated. Therefore, it is possible to miniaturize the fuel cell stack and reduce the electrode area.

As described above, according to the porous channel structure for a fuel cell in accordance with embodiments of the present disclosure, it is possible to improve the flow development of reaction gas in the GDL by causing the reaction gas passing through the channel hole to simultaneously form turbulence both vertically and horizontally.

Hereinabove, although the present disclosure has been described with reference to embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A porous channel structure for a fuel cell, comprising:
a channel plate including a plurality of land parts contacting a gas diffusion layer (GDL) to form a waveform cross-section along a flow direction of gas and a plurality of channel parts contacting a flat plate to maintain water tightness, and having a channel hole through which reaction gas passes,
wherein the channel hole is punched to include a portion of at least one of a land part of the plurality of land parts and a channel part of the plurality of channel parts.

2. The porous channel structure for a fuel cell according to claim 1, wherein the channel hole includes:
a first type channel hole configured to be punched and including a portion contacting the GDL in the land part; and
a second type channel hole configured to be punched and including a portion contacting the flat plate in the channel part.

3. The porous channel structure for a fuel cell according to claim 2, wherein the first type channel hole and the second type channel hole are formed in plural at equidistance from one another along a wave direction of the channel plate.

4. The porous channel structure for a fuel cell according to claim 2, wherein the first type channel hole and the second type channel hole are formed to be positioned along a diagonal line of the channel plate.

5. The porous channel structure for a fuel cell according to claim 2, wherein the reaction gas moves along a curved surface of any of the plurality of land parts, causing directivity and vertical flows in the flat plate, when the reaction gas passes through the first type channel hole.

6. The porous channel structure for a fuel cell according to claim 2, wherein the reaction gas moves along a curved surface of any of the plurality of channel parts, causing directivity and vertical flows in the GDL, when the reaction gas passes through the second type channel hole.

7. The porous channel structure for a fuel cell according to claim 1, wherein a shape of the channel hole is one of a circle, an oval, and a quadrangle.

8. A porous channel structure for a fuel cell, comprising:
a channel plate including a plurality of land parts contacting a gas diffusion layer (GDL) to form a waveform cross-section along a flow direction of gas and a plurality of channel parts contacting a flat plate to maintain water tightness, and having a channel hole through which reaction gas passes,
wherein the channel hole is formed to simultaneously perforate a land part of the plurality of land parts and a channel part of the plurality of channel parts.

9. The porous channel structure for a fuel cell according to claim 8, wherein a width of the channel hole is formed to be equal to or greater than a pitch length which is a sum of a width of the land part and a width of the channel part.

10. The porous channel structure for a fuel cell according to claim 8, wherein the reaction gas passes through the channel hole to simultaneously form vertical turbulence and horizontal turbulence.

11. The porous channel structure for a fuel cell according to claim 8, wherein the channel hole includes a plurality of holes formed in plural at equidistance from one another along a valley formed by a channel.
